(19) United States
(12) Patent Application Publication
(10) Pub. No.: US 2026/0177995 A1
(43) Pub. Date: Jun. 25, 2026

(54) Feedback control system for optimizing performance of a grid-interactive building system using a time-series foundation model

(71) Applicant: Mitsubishi Electric Research Laboratories, Inc., Cambridge, MA (US)

(72) Inventors: Ankush Chakrabarty, Bedford, MA (US); François G Germain, Quincy, MA (US); Jing Liu, Santa Clara, CA (US); Ye Wang, Andover, MA (US); Young-Jin Park, Cambridge, MA (US)

(73) Assignee: Mitsubishi Electric Research Laboratories, Inc., Cambridge, MA (US)

(21) Appl. No.: 18/988,358

(22) Filed: Dec. 19, 2024

(51) Int. Cl. G05B 13/04; G05B 13/02

(52) U.S. Cl. CPC G05B 13/041; G05B 13/0265; G05B 13/048

(57) ABSTRACT

The present disclosure provides a feedback control system for optimizing performance of a grid-interactive building (GIB) system that is configured to condition an indoor environment of a building. The feedback control system comprises a time-series foundation model configured to predict disturbances affecting energy consumption of the building; and a stochastic feedback controller configured to: determine control inputs for the GIB system by evaluating multiple control actions for the GIB system based on the predicted disturbances, wherein the control inputs maximize a likelihood of achieving desired indoor environmental conditions while minimizing the energy consumption. The feedback control system further comprises a feedback mechanism configured to: collect real-time data that includes indoor environmental conditions, an actual energy consumption, and external factors; fine-tune the time-series foundation model using the real-time data; and update the stochastic feedback controller based on a deviation between predicted data and the real-time data.

### TECHNICAL FIELD

The present disclosure relates generally to control systems, and more specifically to a feedback control system and a method for optimizing performance of a grid-interactive building (GIB) system using a time-series foundation model.

### BACKGROUND

Optimization-based control and estimation techniques, such as model predictive control (MPC), allow a model-based design framework in which the system dynamics and constraints can directly be taken into account. MPC is used in many applications to control dynamical systems of various complexities, where the systems are described by a set of nonlinear differential equations, i.e., a system of ordinary differential equations (ODE), differential-algebraic equations (DAE), or partial differential equations (PDE). Examples of such systems include production lines, car engines, robots, numerically controlled machining, satellites, and power generators.

The MPC is based on a real-time finite-horizon optimization of a model of a system. The MPC has the ability to anticipate future events and to take appropriate control actions. This is achieved by optimizing the operation of the system over a future finite time horizon subject to constraints, and only implementing the control over a current time step.

The MPC can predict the change in state variables of the modeled system caused by changes in control variables. The state variables define a state of the system, i.e., a state of a controlled system is the smallest set of state variables in the state-space representation of the control system that can represent the entire state of the system at any given time. For example, if a controlled system is an autonomous vehicle, the state variables may include position, velocity, and heading of the vehicle. The MPC uses models of the system, the current system measurements and/or state estimates, the current state of the vehicle, and state and control constraints to calculate future changes in the state of the vehicle. These changes are calculated to hold the state close to the target subject to constraints on both control and state variables. The MPC typically sends out only the first change in each control variable to be implemented by actuators of the controlled system and repeats the calculation when the next change is required.

Many systems to be controlled are partially unknown, or at least uncertain. E.g., when controlling a vehicle both the maximum friction between tire and road is not exactly known, and furthermore, the dependence of the friction on the state of the vehicle, e.g., the velocity of the vehicle, is also not known. Typically, such uncertainties are estimated concurrently with the MPC, to give the MPC a better knowledge of the model it controls. Although MPC exhibits inherent robustness due to feedback, such controllers do not take uncertainties directly into account and, consequently, the satisfaction of safety-critical constraints cannot be guaranteed in the presence of model uncertainties or external disturbances. One alternative approach is robust MPC, which relies on the optimization of control policies under worst-case scenarios in the presence of a bounded range of uncertainty. However, robust MPC can lead to conservative control performance, due to the worst-case scenarios occurring with an extremely small probability.

Another type of MPC is stochastic MPC (SMPC), where the uncertainty of the system is modeled to have a distribution, e.g., the distribution can be the Gaussian distribution having a mean (center) and a covariance (uncertainty). SMPC aims at reducing the conservativeness of robust MPC by directly incorporating the probabilistic description of uncertainties into the optimal control problem (OCP) formulation. In some implementations, the SMPC requires constraints to be satisfied with a certain probability, i.e., by formulating so-called chance constraints that allow for a specified, yet non-zero, probability of constraint violation. In addition, SMPC is advantageous in settings where high performance in closed-loop operation is achieved near the boundaries of the plant's feasible region. In the general case, chance constraints are computationally intractable and typically require an approximate formulation.

In addition to many systems having uncertain parameters or components, disturbance acting on the system is often uncertain as well. While there are a number of methods for estimating the uncertainty of the parameters or components of the system, these methods depend on the dynamic of the system, while the uncertainty of the disturbance can be independent of the system dynamics.

In addition, some SMPC solvers assume the uncertainty is predetermined offline, i.e., prior to executing the controller. In case of disturbances, such an assumption is overly restrictive, as in numerous applications the uncertainties change with time and can hence not be predetermined offline prior to executing the SMPC.

Accordingly, there is still a need for a control system for controlling the system with uncertainty in the disturbances acting on the system.

### SUMMARY

It is an object of some embodiments to provide a system and a method for controlling and optimizing performance of a system subject to uncertainty of disturbances acting on the system. In an embodiment, the system is a grid-interactive building (GIB) system. The GIB system includes one or more of Heating, Ventilation, and Air Conditioning (HVAC) system, renewable energy sources, and a power grid. The HVAC system, the renewable energy sources, and the power grid are electrically connected with each other.

The HVAC system is installed in a building and configured to condition an indoor environment of the building. For instance, the HVAC system is configured to maintain a temperature and/or humidity of the indoor environment in a desired range or at desired values. The indoor environment of the building refers to a space of a room of the building or a space of a floor of the building. In an embodiment, the HVAC system is powered by electrical energy from the power grid. Additionally, the building is supplied with the electrical energy from the power grid. The power grid is a network of electrical transmission and distribution systems that delivers electricity from power plants to homes, businesses, and other users. It is an infrastructure that enables generation, transmission, and distribution of the electrical energy over long distances.

It is an objective of some embodiments to optimize the performance of the GIB system. For instance, it is an objective of some embodiments to minimize the electrical energy supplied from the power grid by leveraging the renewable energy sources. The renewable energy sources include on-site renewable energy sources and on-site energy storage systems, e.g., photovoltaic systems and batteries associated with the building. It is also an objective of some embodiments to minimize energy consumption of the HVAC system and the building. Additionally, it is an objective of some embodiments of minimize the energy consumption of the HVAC system while maintaining the temperature and the humidity of the indoor environment at the desired values.

To achieve such objectives, embodiments of the present disclosure provide a feedback control system. The feedback control system is communicatively coupled to the GIB system. In some other embodiments, the feedback control system is integrated into the GIB system. The feedback control system includes a processor, a memory, a time-series foundation model, a stochastic feedback controller, and a feedback mechanism. The processor may be a single core processor, a multi-core processor, a computing cluster, or any number of other configurations. The memory may include random access memory (RAM), read only memory (ROM), flash memory, or any other suitable memory systems. Additionally, in some embodiments, the memory may be implemented using a hard drive, an optical drive, a thumb drive, an array of drives, or any combinations thereof. In some embodiments, the time-series foundation model, the stochastic feedback controller, and the feedback mechanism are modules of the feedback control system and are executed by the processor.

The time-series foundation model refers to a type of machine learning model that is specifically designed to handle, understand, and make predictions from time-series data. The time-series data includes sequences of data points, typically ordered by time, and is used to model phenomena that evolve over time. In the present disclosure, the time-series foundation model is a pre-trained model and is configured to predict disturbances affecting energy consumption of the building. The disturbances affecting energy consumption of the building include external factors describing weather conditions, occupancy patterns in the indoor environment, and external temperature variations. The predicted disturbances are input to the stochastic feedback controller.

The stochastic feedback controller is configured to determine control inputs for the GIB system by evaluating multiple control actions for the GIB system based on the predicted disturbances affecting the energy consumption of the building. The control inputs are determined such that the control inputs maximize a likelihood of achieving desired indoor environmental conditions while minimizing the energy consumption. The desired indoor environmental conditions include a desired temperature and a desired humidity of the indoor environment. The control inputs, for example, include a speed of compressor of the HVAC system, a position of an expansion valve, speeds of indoor fan and outdoor fan of the HVAC system. The stochastic feedback controller is further configured to generate control commands to actuators of the HVAC system based on the control inputs and control the actuators of the HAVC system according to the control commands to operate the HVAC system according to the control inputs.

Since the stochastic feedback controller controls the HVAC system according to the control inputs that are determined by considering the predicted uncertainties, the desired temperature and the desired humidity of the indoor environment are achieved accurately while minimizing the energy consumption of the HVAC system and the building. Thereby, optimizing the performance of the GIB system.

Some embodiments are based on the realization that the predictive abilities of the time-series foundation model can be improved by fine-tuning based on real-time data. To this end, some embodiments provide the feedback mechanism that is configured to fine-tune the time-series foundation model based on the real-time data.

To this end, the feedback mechanism is configured to collect real-time data. The real-time data includes indoor environmental conditions, an actual energy consumption by the HVAC system, and external factors. The indoor environmental conditions include temperature, humidity, and Carbon Dioxide (CO₂) levels in the indoor environment. The external factors include ambient temperature, ambient humidity, and solar radiation. Additionally, in some embodiments, the real-time data includes occupant centric inputs such as appliance energy usage.

Further, the feedback mechanism is configured to fine-tune the time-series foundation model based on the real-time data. Fine-tuning the time-series foundation model based on the real-time data improves an accuracy of the prediction of the disturbances. In some embodiments, the feedback mechanism collects the real-time data periodically and updates the time-series foundation model periodically. In such a manner, the feedback control system integrates the predictions of the disturbances from the time-series foundation model with real-time feedback (collected real-time data) to dynamically optimize performance of the HVAC system in response to changing real-time data.

Some embodiments are based on the further realization that the real-time data can be used to adapt the stochastic feedback controller to real-world conditions by aligning predictions with actual outcomes. In particular, the feedback mechanism is configured to update the stochastic feedback controller based on a deviation between predicted data and the real-time data.

Accordingly, one embodiment discloses a feedback control system for optimizing performance of a grid-interactive building (GIB) system that is configured to condition an indoor environment of a building. The feedback control system comprises a time-series foundation model configured to predict disturbances affecting energy consumption of the building; and a stochastic feedback controller configured to: determine control inputs for the GIB system by evaluating multiple control actions for the GIB system based on the predicted disturbances affecting energy consumption of the building, wherein the control inputs maximize a likelihood of achieving desired indoor environmental conditions while minimizing the energy consumption. The feedback control system further comprises a feedback mechanism configured to: collect real-time data that includes indoor environmental conditions, an actual energy consumption, and external factors; fine-tune the time-series foundation model using the collected real-time data; and update the stochastic feedback controller based on a deviation between predicted data and the collected real-time data.

Accordingly, another embodiment discloses a method for optimizing performance of a grid-interactive building (GIB) system that is configured to condition an indoor environment of a building. The method comprises predicting, by a time-series foundation model, disturbances affecting energy consumption of the building; determining, by a stochastic feedback controller, control inputs for the GIB system by evaluating multiple control actions for the GIB system based on the predicted disturbances affecting energy consumption of the building, wherein the control inputs maximize a likelihood of achieving desired indoor environmental conditions while minimizing the energy consumption; and collecting, by a feedback mechanism, real-time data that includes indoor environmental conditions, an actual energy consumption, and external factors; fine-tuning, by the feedback mechanism, the time-series foundation model using the collected real-time data; and updating, by the feedback mechanism, the stochastic feedback controller based on a deviation between predicted data and the collected real-time data.

Accordingly, yet another embodiment discloses a non-transitory computer-readable storage medium embodied thereon a program executable by a processor for performing a method for optimizing performance of a grid-interactive building (GIB) system that is configured to condition an indoor environment of a building. The method comprises predicting, by a time-series foundation model, disturbances affecting energy consumption of the building; determining, by a stochastic feedback controller, control inputs for the GIB system by evaluating multiple control actions for the GIB system based on the predicted disturbances affecting energy consumption of the building, wherein the control inputs maximize a likelihood of achieving desired indoor environmental conditions while minimizing the energy consumption; and collecting, by a feedback mechanism, real-time data that includes indoor environmental conditions, an actual energy consumption, and external factors; fine-tuning, by the feedback mechanism, the time-series foundation model using the collected real-time data; and updating, by the feedback mechanism, the stochastic feedback controller based on a deviation between predicted data and the collected real-time data.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 shows a schematic of an overview of disturbance-aware control employed by some embodiments.

FIG. 2 shows a schematic of the training and inference stages of employing generative artificial intelligence (AI) for disturbance signal generation according to some embodiments.

FIG. 3 shows a schematic of conditional variational autoencoders (CVAEs) employed by some embodiments to provide a mapping between latent and original spaces.

FIG. 4 shows a schematic of an exemplary conditional probabilistic distribution of latent representations according to some embodiments.

FIG. 5 shows a flow chart of a method for determining a conditional probabilistic distribution of the latent representations of disturbance, according to some embodiments.

FIG. 6 shows a schematic of an embodiment employing sigma points derived from estimated scores to produce the conditional probability.

FIG. 7 shows a flowchart of a method employing principles described in relation to FIG. 6.

FIG. 8 shows an example system with uncertainty, connected to a stochastic model predictive controller (SMPC) via a disturbance estimator according to some embodiments.

FIG. 9 shows a diagram of a method implemented by SMPC of FIG. 8 according to some embodiments.

FIGS. 10A-10B show a flowchart of an example process according to some embodiments.

FIG. 11 shows a pseudo-code for performing SMPC using scenario trees according to some embodiments.

FIG. 12 shows a pseudo-code for exemplar implementation scenario trees of SMPC of FIG. 11 for building energy control according to some embodiments.

FIG. 13A illustrates a feedback control system for optimizing performance of a grid-interactive building (GIB) system, according to some embodiments of the present disclosure.

FIG. 13B illustrates fine-tuning of a time-series foundation model, according to some embodiments of the present disclosure.

FIG. 14 illustrates training of the time-series foundation model, according to an embodiment of the present disclosure.

FIG. 15 is a diagram illustrating a general idea of reinforcement learning, according to the embodiments of the present disclosure.

FIG. 16 illustrates joint optimization the time-series foundation model and a stochastic feedback controller, according to some embodiments of the present disclosure.

FIG. 17 illustrates a block diagram for fine-tuning the time-series foundation model using low-rank approximation, according to some embodiments of the present disclosure.

FIG. 18 illustrates applying the low-rank approximation to specific layers of the time-series foundation model, according to some embodiments of the present disclosure.

FIG. 19 illustrates a hierarchical training process, according to some embodiments of the present disclosure.

FIG. 20 shows a block diagram for predicting disturbances for unmonitored zones of a building, according to some embodiments of the present disclosure.

FIG. 21 illustrates the feedback control system including a multivariate quantile function forecaster (MQF2), according to some embodiments of the present disclosure.

FIG. 22A shows a block diagram of a Temporal Fusion Transformer (TFT) model that forms the MQF2, according to some embodiments of the present disclosure.

FIG. 22B illustrates a modified input to the time-series foundation model, according to some embodiments of the present disclosure.

FIG. 23 is a schematic illustrating by non-limiting example a computing apparatus for implementing the methods and the systems of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

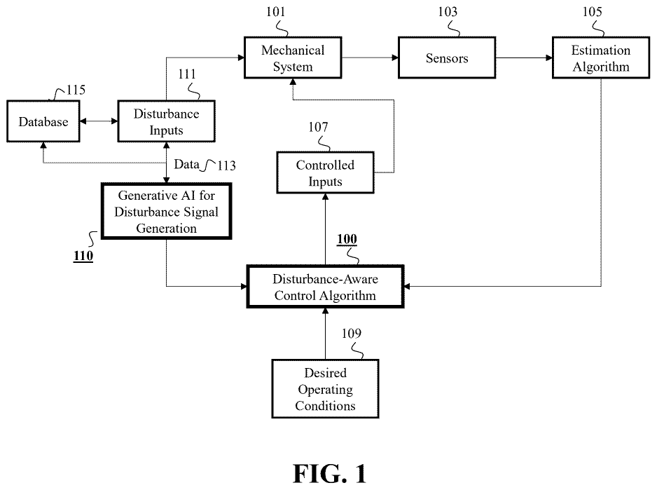

FIG. 1 shows a schematic of an overview of disturbance-aware control employed by some embodiments. The embodiments aim to control a mechanical system 101 that may be described by a model of the dynamics represented by

$${x}_{k + 1} = f ( {x}_{k} , {u}_{k} , {w}_{k} )$$

where xₖ∈ [symbol] ⁿ^{ₓ} denotes the current and state of the system, some of which may be measured by sensors 103, using which estimates of the entire state can be obtained using a state estimation algorithm 105. The vector uₖ∈ [symbol] ⁿ^{ᵤ} denotes a set of control decisions or controlled inputs 107, and wₖ∈ [symbol] ⁿ^{_{w}} denotes the exogenous disturbances 111 which affect the system at the current time k.

For example, the mechanical system can be a thermodynamic system conditioning energy within a building, and the model f may describe the thermal dynamics of an air-conditioned zone in the building, wherein the states of the system x include room air temperature, interior wall surface temperature, and exterior wall core temperatures. The control input u could be the net heating and cooling power of a heat pump, while the disturbance input vector w could be one or a combination of the outside air temperature, solar radiations, airflow, and internal heat loads due to the presence of occupants and heat-generating appliances.

It is the objective of a disturbance-aware control algorithm 100 to achieve desired building operating conditions 109 based on estimates of the states, sensor measurements, and predictions of disturbance inputs. These predictions are generated using generative AI 110 that are trained on data that includes: disturbance inputs 111 potentially measured from the mechanical system 101 in real-time, or disturbance inputs that have been previously stored in a database 115 collected offline, either from the building energy system 101 in the past, or alternative data sources.

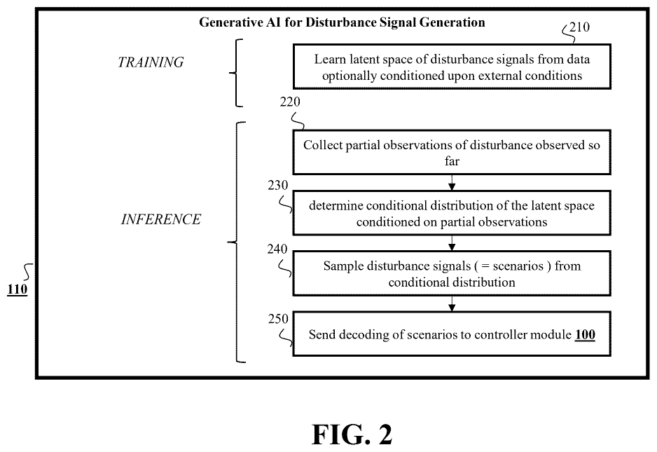

FIG. 2 shows a schematic of the training and inference stages of employing generative ai for disturbance signal generation according to some embodiments. Some embodiments are based on recognizing that measurements of time-series data indicative of disturbance have at least some unknown relationship in the time domain. An example of such a relationship can be observed in sensors measuring power plant operation where future variation in the loads depends on the current values of the loads. Some embodiments are based on the recognition that determining the unknown relationship is challenging as measurements in the original data space of the sensors are noisy and the unknown relationship includes a complex non-linear transformation. For example, in the case of the power plant, the thermodynamic relationship in the power plant is complex and requires extensive domain knowledge to elucidate. Such complex interdependency makes the recovery of the relationship, in the original data space, unreliable. Hence, the assumption of the parameterized structure of the distribution capturing this relationship is unreliable as well.

Some embodiments are based on the realization that efficient encoding of measurements of the sensors may find a relationship among the measurements because encoding methods are used to find reduced-order embeddings of data that summarize their relationships in the original data space. In addition, some embodiments are based on realizing that if the reduced-order embeddings of measurements may better represent the relationship among the measurements, the incorrect assumption of a structure of a probabilistic model of the disturbance in the measurement domain, e.g., the original domain, may become correct in the domain of the reduced-order embeddings of the measurements.

To that end, during the training stage of the control process performed offline, some embodiments learn 210 latent space of reduced-order embeddings of the original measurements of the disturbance where the latent representation of the disturbance can be modeled on a parameterized distribution with sufficient accuracy suitable for control applications. As described below, the embodiments learn a deep generative decoder model defining a mapping from a latent space of latent representations of time-series values of the disturbance affecting the mechanical system over the time horizon to the original, e.g., measurement space of the disturbance.

Notably, the latent space encodes time-series values of the disturbance affecting the mechanical system over the time horizon. For example, during the training, the time horizon can be 24 hours and the time-series values of the disturbance can be the measured disturbance affecting a system over the period of 24 hours. Hence, in this example, each sample in the latent space encodes a 24-hour-long disturbance trajectory.

During the online control, the partial observations of disturbance are collected 220, e.g., measured. For example, the disturbance is measured for the last hour. However, the prediction horizon of the SMPC can be longer than 1 hour. For example, it can be several hours or up to 24 hours in this example. Hence, there is a need to predict the remaining unseen disturbance conditioned on the partial observations of the disturbance. However, given the latent space, the embodiments, instead of trying to determine an unstructured distribution of disturbances conditioned on the partial observations in the original space of measurements, determine 230 the parameterized distribution of the latent representation of the disturbances in the latent space conditioned on the partial observations in the original measurement domains. As described above, due to the nature of the latent space, such estimation is more accurate. The conditional distribution allows the sampling 240 disturbance signals in the latent space and using 250 the decoded latent samples for disturbance-aware stochastic control 100.

To perform such an estimation, some embodiments use a mapping between the latent and the original space determined offline as a deep generative decoder model. Some embodiments are based on the realization that an autoencoder can determine such an efficient mapping in an unsupervised manner. The autoencoder is a type of artificial neural network used to learn efficient data codings in an unsupervised manner. The autoencoder includes an encoder and a decoder. The encoder encodes input data from the original data space into a latent space represented by the vector of numerical values ‘h’. The decoder decodes the encodings from the latent space to an estimate of the input data, i.e., reconstructs the input data. In other words, the encoder and/or decoder provide a mapping between the data in the original data space and a latent space representation of the data. To that end, the autoencoder determines an efficient latent space suitable to capture the relationship between different instances of the input data.

The principles of the autoencoder can be extended to deep generative models, such as variational autoencoders (VAEs) or conditional variational autoencoders (CVAEs), to provide an expressive and automated approach for learning distributions in the latent space from data measured in the original space.

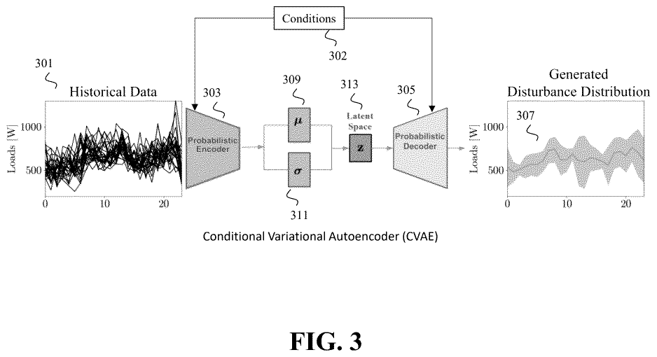

FIG. 3 shows a schematic of conditional variational autoencoders (CVAEs) employed by some embodiments to provide a mapping between the latent and the original spaces. The CVAE models the disturbance sequence W≡W_{[0,T]}:=(w₀, . . . , w_{T}) over a time span [0, T], optionally conditioned on an environmental variable c∈[0, 1]ⁿ^{_{c}} 302 which captures the conditions for which disturbance inputs may change in structure, frequency, or other signal characteristics. In embodiments controlling air-conditioning systems, condition c includes seasons, workday vs. weekend, average diurnal temperature, humidity, and/or average solar radiation, geographical location (when considering multiple buildings).

Various embodiments use a probabilistic deep learning method that learns a latent space by encoding disturbance signal data; this latent space can be interpreted as a conditional probability distribution: sampling which, one can obtain disturbance signals by decoding. The CVAE includes an encoder 303 that compresses data signals W 301, given conditional inputs c 302, to a latent representation z 313 in a latent space within [symbol] ⁿ^{_{z}}, and a decoder 305 that is trained to reconstruct the data from the learned latent representation.

The generative model is specified by the distribution π_{θ}(W|z, c) where z is sampled from a latent prior distribution π(z) and θ are the encoder weights. This implicitly specifies the conditional distribution:

$$π ( W \vert c ) = \int π ( W \vert z , c ) π ( z ) dz .$$

In principle, the learning objective is to maximize the expected log-likelihood, i.e.,

$${max}_{θ} E [ log {π}_{θ} ( W \vert c ) ] .$$

However, this implicit conditional distribution is generally intractable, which motivates the introduction of a variational posterior q_{φ}(z|W, c) that approximates the actual posterior; φ are the decoder weights. This q_{φ} is utilized in a variational lower bound of the expected log-likelihood, also known as the evidence lower bound (ELBO)

$$E [ log {π}_{θ} ( W \vert c ) ] \geq E [ log {π}_{θ} ( W \vert z , c ) + KLD ( {q}_{ϕ} ( z \vert W , c ) ‖ π ( z ) ) ] .$$

The parameters (θ, φ) of the CVAE are jointly optimized to maximize the ELBO. Note that the variational posterior is typically parameterized as a conditional Gaussian:

$${q}_{ϕ} ( z \vert W , c ) = 𝒩 ( z ; {μ}_{ϕ} ( W , c ) , {\sum }_{ϕ} ( W , c ) ) ,$$

with the mean vector μ_{φ} 309 and diagonal covariance matrix Σ_{φ}311 given by parametric functions of (x, s). With the typical assumption of a latent prior distribution being the standard Gaussian distribution, the KLD term in ELBO is readily tractable and differentiable.

The variational posterior can be viewed as an encoder that induces a probabilistic map from W to a latent representation z, conditioned on c. The generative model can be viewed as a decoder that recovers likelihoods for W, conditioned on c, from a sampled latent representation z. This decoder can also be parameterized as a conditional Gaussian, where the mean vector is a parametric function of (z, c) and the covariance is the identity matrix. This simplifies the first term of the ELBO in to be essentially a negative reconstruction loss, i.e., shift-scale of mean-square error (MSE).

Given a trained VAE, the decoder can be used to generate synthetic data 307 by sampling from the latent variables, π_{θ}(W|z, c). This is done by drawing a latent vector z from its prior distribution, and subsequently, for a given c, employing the generative model to specify the distribution π_{θ}(W|z, c) from which the synthetic data should be sampled.

However, the deep generative decoder model 305 is trained offline from the training data of measured disturbances without consideration of the current partially observed disturbances acting on the mechanical system. To address the partial observations, the embodiments use the deep generative decoder model to determine a conditional probabilistic distribution of the latent representations of the disturbance conditioned on the partial observations of the disturbance.

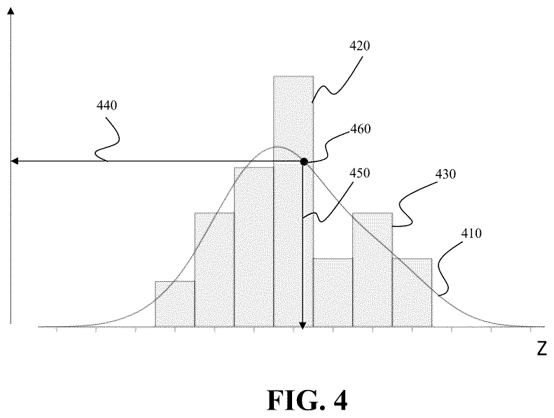

FIG. 4 shows a schematic of an exemplary conditional probabilistic distribution of the latent representations according to some embodiments. The conditional probabilistic distribution 410 of the latent representations of the disturbance is determined based on a comparison of corresponding portions of a set of latent representations decoded by the deep generative decoder model with the partial observations of the disturbance. For example, in the example of FIG. 4, decodings of the latent samples from area 420 are more likely to fit the partial observations than decodings of the latent samples from area 420.

Some embodiments sample 460 the conditional distribution 410 to produce a latent sample 450 and its probability 440 to represent the partial observations. The decoding of the latent sample 450 and its probability 440 are used by SMPC for the stochastic control.

Different embodiments use different techniques to determine the conditional distribution 410. For example, some embodiments determine the conditional probabilistic distribution of the latent representations of the disturbance based on a comparison of corresponding portions of a set of latent representations decoded by the deep generative decoder model with the partial observations of the disturbance.

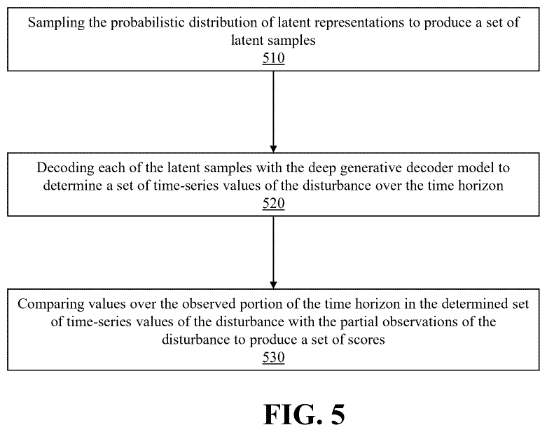

FIG. 5 shows a flow chart of a method for determining the conditional probabilistic distribution of the latent representations of the disturbance according to some embodiments. The method includes sampling 510 the probabilistic distribution of latent representations to produce a set of latent samples; decoding 520 each of the latent samples with the deep generative decoder model to determine a set of time-series values of the disturbance over the time horizon, wherein each of time-series values of the disturbance includes values over the observed portion of the time horizon; and comparing 530 values over the observed portion of the time horizon in the determined set of time-series values of the disturbance with the partial observations of the disturbance to produce a set of scores.

These scores are used to build the conditional distribution 410. For example, some embodiments iteratively repeat the sampling 510, the decoding 520, and the comparing 530 until a termination condition is met to reduce an error between the values over the observed portion of the time horizon in the determined set of time-series values of the disturbance and the partial observations of the disturbance. Doing this in such a manner allows for identifying the area of the latent space with a higher probability of fitting the partial observation of the disturbance. The observed error is used to estimate the conditional probability of different samples.

For example, given pre trained decoder model, during an online control of the mechanical system at the current time t, the embodiments collect partial observations of measured disturbances W_{0:t}=(w₀, . . . , w_{T}) and aim to leverage a pre-trained CVAE model to provide a distributional forecast of the remaining unknown sequence W_{t+1:T}=(wₜ₊₁, . . . , w_{T}). Formally speaking, the aim is to extract and sample the conditional distribution π(W_{t+1:T}|W_{0:t}, c) from the model learned by the CVAE.

However, this specific conditional dependency structure is not directly provided by the CVAE. Instead, the embodiments first extract the latent representation distribution conditioned on only the partially revealed perturbations, π(z|W_{0:t}, c), equivalently, to identify a subspace in the latent space that is most likely to have generated the observed disturbance sequence W_{0:t} conditioned upon c. Then, by sampling latents from this distribution z˜π(z|W_{0:t}, c), the embodiments apply the CVAE decoder model to sample the corresponding completed sequences, including the unseen portions W_{t+1:T}, which is equivalent to predicting (probabilistically) 211 the disturbance input signal.

The conditional latent distribution π(z|W_{0:t}, c), although not known in closed form, can be defined using Bayes' rule. Formally, the latent probability distribution conditioned on the partially revealed sequence is defined as,

$$π ( z \vert {W}_{0 : t} , c ) = \frac{π ( Z \vert C ) π ( {W}_{0 : t} \vert z , c )}{π ( {W}_{0 : t} \vert c )} .$$

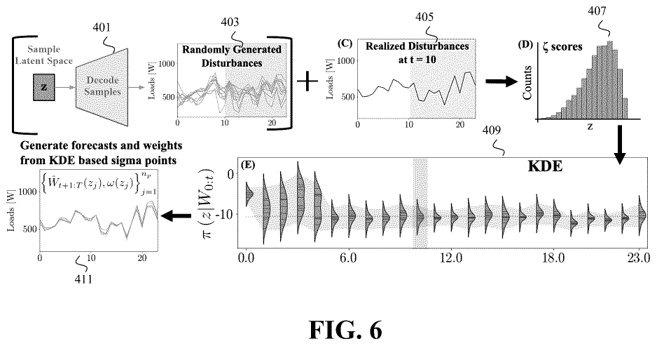

FIG. 6 shows a schematic of an embodiment employing sigma points derived from the estimated scores to produce the conditional probability. The embodiment generates m samples z over a learned latent space 401, and decodes the latent samples 403 with the deep generative decoder model to produce the corresponding reconstructions of the seen portion of the disturbance sequences

$${\{ ) \}}_{i = 1}^{m} .$$

The embodiment compares the reconstruction with the partially observed disturbance. For example, one implementation of the embodiment uses the coefficient of determination (the square of the Pearson correlation coefficient) on each reconstruction 403 with the original partially observed sequence of the disturbance 405 to assign a score 407 to the likelihood of each corresponding sample zi, as given by,

$${ζ}_{i} = \frac{α}{1 - {R ( {\hat{W}}_{0 : t} ( {z}_{i} ) , {W}_{0 : t} )}^{2}}$$

with scalar a>0.

These zeta-scores 407 enable the approximation of the likelihood π(z|W_{0:t}) using kernel density estimation (KDE) 409. The KDE can be sampled to obtain nₚ sigma points in the latent space, where we recall that nₚ=2n_{z}+1 and n_{z} is the dimension of the latent distribution. After KDE approximation and sigma-point construction, the likelihood π(z|W_{0:t}) gradually adapts 409 to a latent vector likely to have generated W_{0:t}.

These latent samples, along with their probabilities, are then passed to the decoder to produce conditionally sampled forecasts of the unseen portion of the disturbance sequence and weights 411 which are subsequently passed to the SMPC through the predicted dynamics.

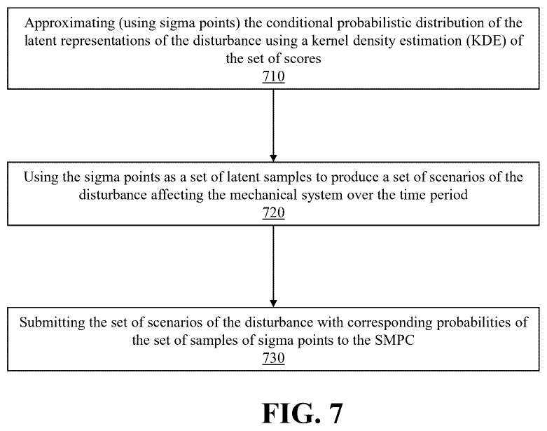

FIG. 7 shows a flowchart of a method employing principles described in relation to FIG. 6. The method includes approximating 710 the conditional probabilistic distribution of the latent representations of the disturbance conditioned on the partial observations of the disturbance using a kernel density estimation (KDE) of the set of scores. For example, the conditional probabilistic distribution is approximated as a set of samples of sigma points on the KDE of the set of scores. Next, the method uses 720 the set of samples of sigma points as a set of latent samples of the time-series values of the disturbance affecting the mechanical system over the time horizon to produce a set of scenarios of the disturbance affecting the mechanical system over the time period and submits 730 the set of scenarios of the disturbance with corresponding probabilities of the set of samples of sigma points to the predictive controller to produce the control commands by optimizing a cost function of the set of the scenarios weighted with the corresponding probabilities.

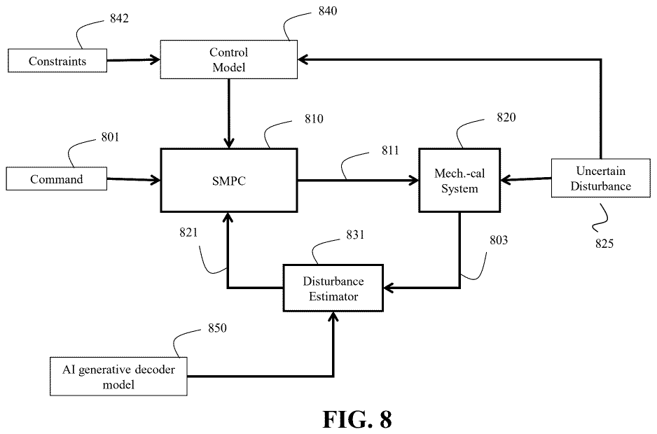

FIG. 8 shows an example system 820 with uncertainty 825, connected to a stochastic model predictive controller (SMPC) 810 via a disturbance estimator 831 according to some embodiments. The SMPC is programmed according to a dynamical model 840, i.e., a control model of the system. The model can be a set of equations representing changes in the state and output 803 of the system 820 over time as functions of current and previous inputs 811 and previous outputs 803. The model can include constraint 842 which represents the physical and operational limitations of the system. During the operation, the controller receives a command 801 indicating the desired behavior of the system. The command can be, e.g., a motion command. In response to receiving the command 801, the controller generates a control signal 811 that serves as an input for the mechanical system 820 affected by the disturbance 825. In response to the input, the system updates the output 803 of the system. Based on measurements of the output of system 803 and an AI deep generative decoder model 850, the estimator 831 predicts 821 the disturbance 825, and its uncertainty. These estimates 821 are submitted to controller 810.

The mechanical system 820, as referred to herein, can be any machine or device controlled by certain manipulation input signals 811 (inputs), possibly associated with physical quantities such as voltages, pressures, forces, and torques, and to return some controlled output signals 803 (outputs), possibly associated to physical quantities such as currents, flows, velocities, positions indicative of a transition of a state of the system from a previous state to the current state. The output values are related in part to previous output values of the system and in part to previous and current input values. The dependency on previous inputs and previous outputs is encoded in the state of the system. The operation of the system, e.g., a motion of components of the system, can include a sequence of output values generated by the system following the application of certain input values.

The uncertain disturbance 825 can be any time-varying signal, including any external disturbances, forces or torques acting on the system 820, any unmodeled dynamics, or any uncertainties in physical quantities such as uncertain friction coefficients, friction functions, a mass of a body, center of gravity of the system, or uncertain coefficients and parameters in the control model equations that describe the physical behavior of the real system 820. For example, in some implementations, the SMPC 810 uses a simplified control model 840, resulting in a large amount of the physical behavior in the mechanical system remaining unmodeled, to reduce the computational complexity of the controller or because some of the physical behavior is too complex and therefore difficult or impossible to model by first principles. Such simplified modeling can cause or contribute to the uncertainty 825. Note that time-independent uncertainties can be estimated or learned, either online or offline, as part of the state and parameter estimator 831.

In various embodiments, the estimator 831 is an online estimator that determines the uncertain disturbance 825 and/or confidence about the estimated uncertainty in real-time, i.e., during the control of the system 820. In such a manner some embodiments increase the accuracy of the estimation of the uncertainty 825 with respect to the accuracy of offline estimation of the uncertainties because the uncertainty 825 is changing with time and may depend on the control inputs and the system response to such control inputs.

A control model 840 can include a dynamic model defining the dynamics of the system 820. The control model 840 of mechanical system 820 can include a set of mathematical equations that describe how the system outputs change over time as functions of current and previous inputs and the previous outputs. The state of the system is any set of information, in general time-varying, for instance, an appropriate subset of current and previous inputs and outputs, that, together with the model of the system and future inputs, can uniquely define the future motion of the system. The mechanical system 820 can be subject to physical limitations and specification constraints 842 limiting the range where the outputs, the inputs, and also possibly the states of the system are allowed to operate. In various embodiments, the control model of the system includes a function of dynamics of the system having the parameter with the uncertainty 825. In such a manner, the uncertainty acting on the system 820 can be captured by the model 840.

The controller 810 can be implemented in hardware or as a software program executed in a processor, e.g., a microprocessor, which at fixed or variable control period sampling intervals receives the estimated state of the system 821 and the desired motion command 801 and determines, using this information, the inputs, e.g., the control signal 811, for operating the system.

The estimator 831 can be implemented in hardware or as a software program executed in a processor, either the same or a different processor from the controller 810, which at fixed or variable control period sampling intervals receives the outputs of the system 803 and determines, using the new and the previous output measurements, the estimated disturbance and its uncertainty 821 of the system 820.

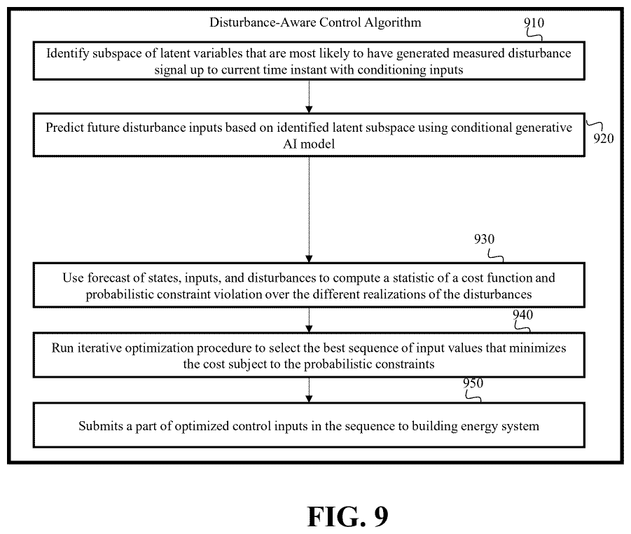

FIG. 9 shows a diagram of a method implemented by SMPC of FIG. 8 according to some embodiments. Given a deep generative decoder model defining a mapping from a latent space of latent representations of time-series values of the disturbance affecting the mechanical system over the time horizon to a measurement space of the partial observations of the disturbance, the method identifies 910 subspace of latent variables that are most likely to have generated measured disturbance signal up to current time instant with conditioning inputs. The identifying 910 can be implemented as conditional probabilistic distribution of the latent representations of the disturbance conditioned on the partial observations of the disturbance.

Using the identified subspace of latent variables, the method predicts 920 future disturbance inputs based on the identified latent subspace using the deep generative decoder model and uses this prediction to forecast 930 states, inputs, and disturbances to compute a statistic of a cost function and probabilistic constraint violation over the different realizations of the disturbances, e.g., as described with respect to FIG. 8. For example, the SMPC determines the control commands by optimizing a cost function over a prediction horizon including the observed portion of the time horizon and an unobserved portion of the time horizon, wherein time-series values of the disturbance affecting the mechanical system over the prediction horizon include the partial observations of the disturbance complemented with a portion of the predicted values of the disturbance for the unobserved portion of the time horizon. Notably, in different implementations, the prediction horizon is shorter than the time horizon or equal to the time horizon of the decoded disturbance.

Next, the SMPC runs 940 iterative optimization procedure to select the best sequence of input values that minimizes the cost subject to the probabilistic constraints over the prediction horizon and submits 950 a part of optimized control inputs in the sequence to the actuators of the mechanical system.

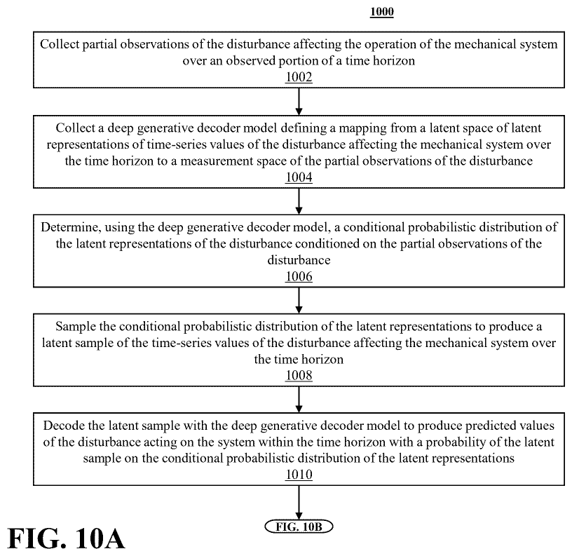

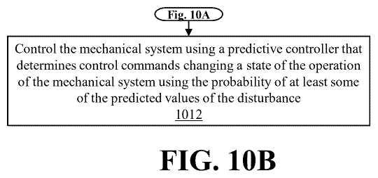

FIGS. 10A-10B show a flowchart of an example process 1000. In some implementations, one or more process blocks of FIGS. 10A-10B may be performed by a processor. As shown in FIGS. 10A-10B, process 1000 may include collecting partial observations of the disturbance affecting the operation of the mechanical system over an observed portion of a time horizon (block 1002). For example, processor may collect partial observations of the disturbance affecting the operation of the mechanical system over an observed portion of a time horizon, as described above. As also shown in FIGS. 10A-10B, process 1000 may include collecting a deep generative decoder model defining a mapping from a latent space of latent representations of time-series values of the disturbance affecting the mechanical system over the time horizon to a measurement space of the partial observations of the disturbance (block 1004). For example, processor may collect a deep generative decoder model defining a mapping from a latent space of latent representations of time-series values of the disturbance affecting the mechanical system over the time horizon to a measurement space of the partial observations of the disturbance, as described above.

As further shown in FIGS. 10A-10B, process 1000 may include determining, using the deep generative decoder model, a conditional probabilistic distribution of the latent representations of the disturbance conditioned on the partial observations of the disturbance (block 1006). For example, processor may determine, using the deep generative decoder model, a conditional probabilistic distribution of the latent representations of the disturbance conditioned on the partial observations of the disturbance, as described above.

As also shown in FIGS. 10A-10B, process 1000 may include sampling the conditional probabilistic distribution of the latent representations to produce a latent sample of the time-series values of the disturbance affecting the mechanical system over the time horizon (block 1008). For example, processor may sample the conditional probabilistic distribution of the latent representations to produce a latent sample of the time-series values of the disturbance affecting the mechanical system over the time horizon, as described above.

As further shown in FIGS. 10A-10B, process 1000 may include decoding the latent sample with the deep generative decoder model to produce predicted values of the disturbance acting on the system within the time horizon with a probability of the latent sample on the conditional probabilistic distribution of the latent representations (block 1010). For example, processor may decode the latent sample with the deep generative decoder model to produce predicted values of the disturbance acting on the system within the time horizon with a probability of the latent sample on the conditional probabilistic distribution of the latent representations, as described above.

As also shown in FIGS. 10A-10B, process 1000 may include controlling the mechanical system using a predictive controller that determines control commands changing a state of the operation of the mechanical system using the probability of at least some of the predicted values of the disturbance (block 1012). For example, processor may control the mechanical system using a predictive controller that determines control commands changing a state of the operation of the mechanical system using the probability of at least some of the predicted values of the disturbance, as described above.

Although FIGS. 10A-10B shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

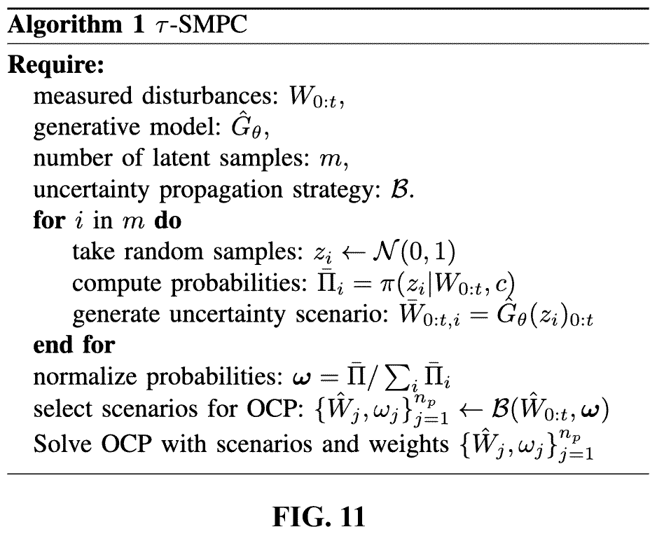

FIG. 11 shows a pseudo-code for performing SMPC using scenario trees according to some embodiments. While SMPC is an extension of MPC that accounts for uncertainties in the system by modeling them as stochastic processes, the scenario trees are a tool used in stochastic MPC to represent and handle these uncertainties. Some embodiments are based on recognizing that the scenario trees can be advantageously used to handle different predictions of the disturbance sampled with different probabilities on the conditional distribution.

As a skilled artisan readily recognizes, scenario trees are constructed to represent different possible realizations of the uncertain variables over a prediction horizon. Each branch of the tree corresponds to a particular scenario or realization of the uncertainties. Nodes in the scenario tree represent decision points in time, such as sampling instants for control inputs or prediction steps. At each node, the system faces a decision, and the tree branches based on different possible outcomes. Each branch of the scenario tree is associated with a probability weight that reflects the likelihood of that particular scenario occurring. As described above, these probabilities are estimated based on the conditional distribution.

The objective function in stochastic MPC is defined as the expected cost over all possible scenarios, taking into account the probability of each scenario. This involves weighting the cost associated with each scenario by its probability of occurrence. The optimization problem in stochastic MPC involves finding the control inputs that minimize the expected cost over the entire scenario tree. This leads to a more robust controller that performs well on average across different possible outcomes.

Stochastic MPC typically employs a receding horizon control strategy. At each time step, the controller solves the optimization problem over the current scenario tree, implements the first set of control inputs, and then updates the scenario tree based on new measurements. As time progresses, the actual system behavior is observed, and the scenario tree may be updated to incorporate new information. This adaptive approach helps the controller become more accurate over time.

Scenario trees provide a structured way to handle uncertainties and make decisions in a stochastic environment. They allow the MPC controller to explicitly consider multiple possible disturbance scenarios, making the control strategy more robust and capable of handling real-world uncertainties.

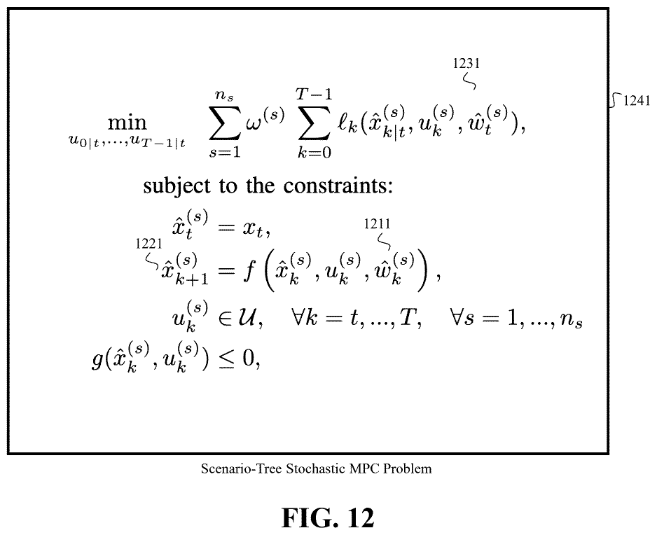

FIG. 12 shows a pseudo-code for exemplar implementation scenario trees of SMPC of FIG. 11 for building energy control according to some embodiments. This implementation is based on recognizing that although the conditional distribution is not available in closed form, it can be numerically approximated. First, note that π(W_{0:T}|z, c) is defined by the decoder, which uses the learned distribution and reparameterization to generate samples Ŵ_{0:T}. By assuming a Gaussian prior centered on the evidence, the embodiments can numerically evaluate the conditional probability of latent samples, using

$$π ( {W}_{0 : t} \vert z , c ) = \frac{1}{β} exp ( \frac{- {{δ}_{M} ( {μ}_{θ , 0 : t} , {\sum }_{θ , 0 : t}^{- 1} )}^{2}}{2} )$$

where δ_{M} is the Mahalanobis distance, and β is the pre-exponential factor for a multivariate Gaussian. We can now generate forecasts and compute their respective probability by jointly sampling the decoder and probability function.

Given π(z|W_{0:t}, c) and disturbance forecasts W_{t+1:T}, we require a scenario selection strategy to select the forecasts to use in the SMPC. Construction of the scenario tree for non-i.i.d. disturbances require the transition probabilities between any two consecutive states in a scenario. However, when building a scenario tree from generated forecasts, state-transition probabilities π(Wᵢ₊₁|Wᵢ, c)∀i∈[t:T−1] are not known and would be expensive to compute. Instead, generated samples can be directly used in a single-stage robust horizon decision tree, where each scenario is a generated forecast.

Given that the learned distribution can produce all possible scenarios, it will also contain all the scenarios of a tree with arbitrarily long robust horizons, without the need for explicitly defining branches and transition probabilities. Thus, by taking a subset of forecasts can be likened to a pruned scenario tree.

Different implementations utilize different strategies for the scenario selection. For example, in one embodiment the scenarios are generated by using the most probable forecasts A⊂{Ŵ_{t+1:T}(z)}, and generating scenarios

$${\hat{W}}_{t + 1 : T}^{( 1 )} = 𝔼 [ A ] + {ξ}_{0} σ ( A )$$

$${\hat{W}}_{t + 1 : T}^{( 2 )} = 𝔼 [ A ] + {ξ}_{2} σ ( A )$$

$${\hat{W}}_{t + 1 : T}^{( 3 )} = 𝔼 [ A ] + {ξ}_{3} σ ( A )$$

$$…$$

$${\hat{W}}_{t + 1 : T}^{( {n}_{s} )} = 𝔼 [ A ] + {ξ}_{{n}_{s}} σ ( A ) ,$$

for a user-specified nₛ, generated using the mean and standard deviation over A. The scalars ξ=[ξ₀, ξ₁, . . . , ξₙ] can be used to select lower probability scenarios, using the normalized probability values of an isotropic Gaussian as the weights. Thus using a single scenario is equivalent to a MPC implementation, and increasing the number of scenarios and/or values of ξ results in more conservative control.

Additionally or alternatively, for non-adaptive strategies, the scenarios can be generated as outlined above, except where α is the set of most probable scenarios generated by sampling z˜ [symbol] (0,1), i.e., the unconditioned prior.

The control decisions are made using a scenario-tree SMPC framework 1241 where the scenarios have been generated as discussed above. Here ω^{s} 1231 is the weight for scenario s, and [symbol] ₖ is a stage cost function such as energy or deviation from a comfortable temperature zones, or an economic objective. Additionally,

$${\hat{x}}_{k}^{s} , {\hat{w}}_{k}^{s}$$

are the predicted states and forecasted disturbance values via the dynamics 1221 and the generative AI method 1211, and g is a set of probabilistic constraint functions. Considering the above, the embodiments can therefore forecast states, inputs, and disturbances to compute a statistic of a cost function and probabilistic constraint violation over the different realizations of the disturbances.

Consequently, the SMPC can solve this scenario-tree optimal control problem using various iterative optimization methods, and send a part of the optimal control solution to the building energy system.

### Optimizing Performance of a Grid-Interactive Building System Subject to Disturbances, Using Time-Series Foundation Model:

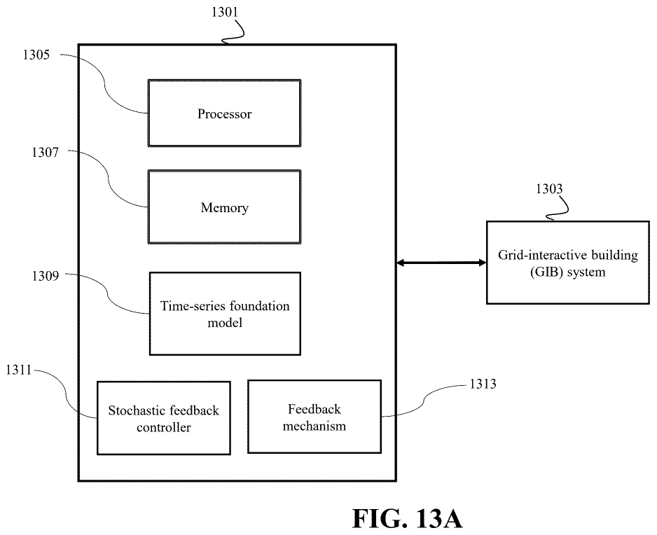

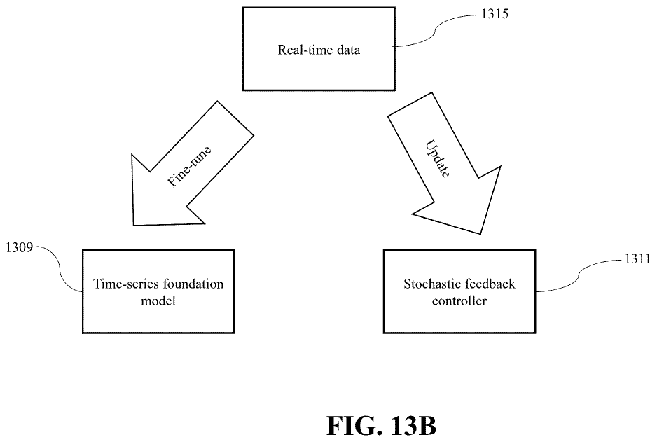

FIG. 13A illustrates a feedback control system 1301 for optimizing performance of a grid-interactive building (GIB) system 1303, according to some embodiments of the present disclosure. The GIB system 1303 includes one or more of Heating, Ventilation, and Air Conditioning (HVAC) system, renewable energy sources, and a power grid. The HVAC system, the renewable energy sources, and the power grid are electrically connected with each other.

The HVAC system is installed in a building and configured to condition an indoor environment of the building. For instance, the HVAC system is configured to maintain a temperature and/or humidity of the indoor environment in a desired range or at desired values. The indoor environment of the building refers to a space of a room of the building or a space of a floor of the building. In an embodiment, the HVAC system is powered by electrical energy from the power grid. Additionally, the building is supplied with the electrical energy from the power grid. The power grid is a network of electrical transmission and distribution systems that delivers electricity from power plants to homes, businesses, and other users. It is an infrastructure that enables generation, transmission, and distribution of the electrical energy over long distances.

It is an objective of some embodiments to optimize the performance of the GIB system 1303. For instance, it is an objective of some embodiments to minimize the electrical energy supplied from the power grid by leveraging the renewable energy sources. The renewable energy sources include on-site renewable energy sources and on-site energy storage systems, e.g., photovoltaic systems and batteries associated with the building. It is also an objective of some embodiments to minimize energy consumption of the HVAC system and the building. Additionally, it is an objective of some embodiments of minimize the energy consumption of the HVAC system while maintaining the temperature and the humidity of the indoor environment at the desired values.

To achieve such objectives, embodiments of the present disclosure provide the feedback control system 1301. The feedback control system 1301 is communicatively coupled to the GIB system 1303. In some other embodiments, the feedback control system 1301 is integrated into the GIB system 1303. The feedback control system 1301 includes a processor 1305, a memory 1307, a time-series foundation model 1309, a stochastic feedback controller 1311, and a feedback mechanism 1313. The processor 1305 may be a single core processor, a multi-core processor, a computing cluster, or any number of other configurations. The memory 1307 may include random access memory (RAM), read only memory (ROM), flash memory, or any other suitable memory systems. Additionally, in some embodiments, the memory 1307 may be implemented using a hard drive, an optical drive, a thumb drive, an array of drives, or any combinations thereof. In some embodiments, the time-series foundation model 1309, the stochastic feedback controller 1311, and the feedback mechanism 1313 are modules of the feedback control system 1301 and are executed by the processor 1305.

The time-series foundation model 1309 is a pre-trained model and is configured to predict disturbances affecting energy consumption of the building. The disturbances affecting energy consumption of the building include external factors describing weather conditions, occupancy patterns in the indoor environment, and external temperature variations. The predicted disturbances are input to the stochastic feedback controller 1311.

The stochastic feedback controller 1311 is configured to determine control inputs for the GIB system 1303 by evaluating multiple control actions for the GIB system based on the predicted disturbances affecting the energy consumption of the building. The control inputs are determined such that the control inputs maximize a likelihood of achieving desired indoor environmental conditions while minimizing the energy consumption. The desired indoor environmental conditions include a desired temperature and a desired humidity of the indoor environment. The control inputs, for example, include a speed of compressor of the HVAC system, a position of an expansion valve, speeds of indoor fan and outdoor fan of the HVAC system. The stochastic feedback controller 1311 is further configured to generate control commands to actuators of the HVAC system based on the control inputs and control the actuators of the HAVC system according to the control commands to operate the HVAC system according to the control inputs.

Since the stochastic feedback controller 1311 controls the HVAC system according to the control inputs that are determined by considering the predicted uncertainties, the desired temperature and the desired humidity of the indoor environment are achieved accurately while minimizing the energy consumption of the HVAC system and the building. Thereby, optimizing the performance of the GIB system 1303.

Some embodiments are based on the realization that the predictive abilities of the time-series foundation model 1309 can be improved by fine-tuning based on real-time data. To this end, some embodiments provide the feedback mechanism 1313 that is configured to fine-tune the time-series foundation model 1309 based on the real-time data.

FIG. 13B illustrates fine-tuning of the time-series foundation model 1309, according to some embodiments of the present disclosure. The stochastic feedback mechanism 1313 is configured to collect real-time data 1315. The real-time data 1315 includes indoor environmental conditions, an actual energy consumption by the HVAC system, and external factors. The indoor environmental conditions include temperature, humidity, and Carbon Dioxide (CO₂) levels in the indoor environment. The external factors include ambient temperature, ambient humidity, and solar radiation. Additionally, in some embodiments, the real-time data 1315 includes occupant centric inputs such as appliance energy usage.

Further, the feedback mechanism 1313 is configured to fine-tune the time-series foundation model 1309 based on the real-time data 1315. Fine-tuning the time-series foundation model 1309 based on the real-time data 1315 improves an accuracy of the prediction of the disturbances. In some embodiments, the feedback mechanism 1313 collects the real-time data 1315 periodically and updates the time-series foundation model 1309 periodically. In such a manner, the feedback control system 1301 integrates the predictions of the disturbances from the time-series foundation model 1309 with real-time feedback (collected real-time data) to dynamically optimize performance of the HVAC system in response to changing real-time data.

Some embodiments are based on the further realization that the real-time data 1315 can be used to adapt the stochastic feedback controller 1311 to real-world conditions by aligning predictions with actual outcomes. In particular, the feedback mechanism 1313 is configured to update the stochastic feedback controller 1313 based on a deviation between predicted data and the real-time data 1315. The predicted data includes an energy consumption of the HVAC system and/or the building predicted by the stochastic feedback controller 1313.

In an embodiment, the stochastic feedback controller 1311 uses Bayesian inference to evaluate the multiple control actions for the GIB system 1303. The Bayesian inference is a statistical method that allows to update a probability of a hypothesis or event based on new data. The Bayesian inference is based on Bayes' Theorem, which describes the probability of the hypothesis given some observed data. The Bayesian inference involves beginning with a prior belief about the hypothesis (called the prior probability), and then updating the prior belief based on the new data (called the likelihood) to obtain a more refined belief (the posterior probability).

In another embodiment, the stochastic feedback controller 1311 a stochastic optimization technique to evaluate the multiple control actions for the GIB system 1303. The stochastic optimization technique refers to a class of optimization techniques that involve randomness or probabilistic elements in their processes. These techniques are used to solve optimization problems where an objective function or constraints are affected by uncertainty, noise, or randomness, or when it's infeasible to evaluate the objective function deterministically due to factors like complex calculations, high computational cost, or incomplete data. Examples of the stochastic optimization technique include Stochastic Gradient Descent (SGD), simulated annealing, and stochastic programming.

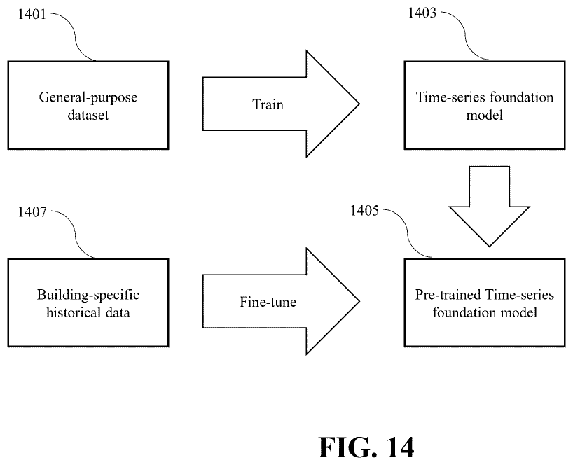

FIG. 14 illustrates training of the time-series foundation model 1309, according to an embodiment of the present disclosure. The time-series foundation model 1309 refers to a type of machine learning model that is specifically designed to handle, understand, and make predictions from time-series data. The time-series data includes sequences of data points, typically ordered by time, and is used to model phenomena that evolve over time. A foundation model in this context is a pre-trained, large, and general-purpose model that is designed to capture complex patterns in the time-series data. The foundation model can be fine-tuned or adapted for specific tasks using the time-series data as input.

In the present disclosure, a time-series foundation model 1403 is pre-trained on a general-purpose dataset 1401 to obtain a pre-trained time-series foundation model 1405. The general-purpose dataset 1401 includes large and diverse set of time-series data that is used to help the time-series foundation model learn general temporal patterns, structures, and relationships across different domains. The general-purpose dataset 1401 is large enough to capture a wide variety of temporal patterns and behaviors. This allows the time-series foundation model 1403 to be generalized across multiple domains and tasks. Further, the diverse set of time-series data includes time-series data from different sources and industries (e.g., finance, healthcare, weather, retail, energy) to ensure the time-series foundation model 1403 can handle different kinds of time-series phenomena such as seasonality, trends, and noise.

The pre-trained time-series foundation model 1405 is fine-tuned using building-specific historical data 1407 to adapt to the building's energy consumption patterns to obtain the time-series foundation model 1309. In particular, the fine-tuning updates the pre-trained time-series foundation model 1405 to capture specific features of the building energy consumption, such as daily cycles, seasonal trends, the occupancy patterns, and responses to environmental factors (e.g., weather, time of day). The building-specific historical data 1407 includes data collected directly from energy meters or sensors in the building, showing the total energy usage over time (typically hourly or minute-based data). The collected data includes historical data about electricity, heating, cooling, or even gas consumption. Additionally, in some embodiments, the building-specific historical data 1407 includes the occupancy patterns that can help the time-series foundation model 1309 to understand a correlation between the energy consumption of the HVAC system and a number of people in the building.

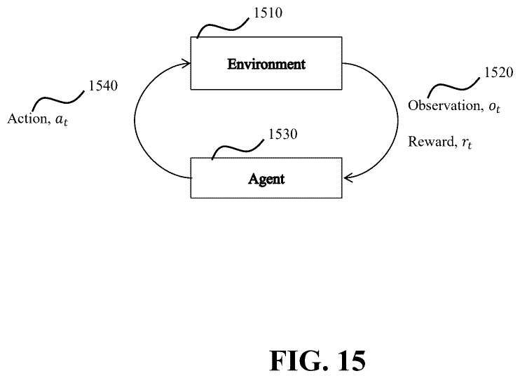

In some embodiments, the feedback mechanism 1313 is configured to update the time-series foundation model 1309 based on the real-time data 1315 using a reinforcement learning framework. FIG. 15 is a diagram illustrating a general idea of the reinforcement learning, according to the embodiments of the present disclosure. The reinforcement learning is a learning framework that handles sequential decision-making problems, wherein an ‘agent’ 1530 or decision maker learns a policy to optimize a long-term reward by interacting with an (unknown) environment 1510. At each time step, a reinforcement learning agent obtains evaluative feedback (called reward or cost) 1550 about the performance of its action 1540 along with an observation of the environment, allowing it to improve (maximize or minimize) performance of subsequent actions.

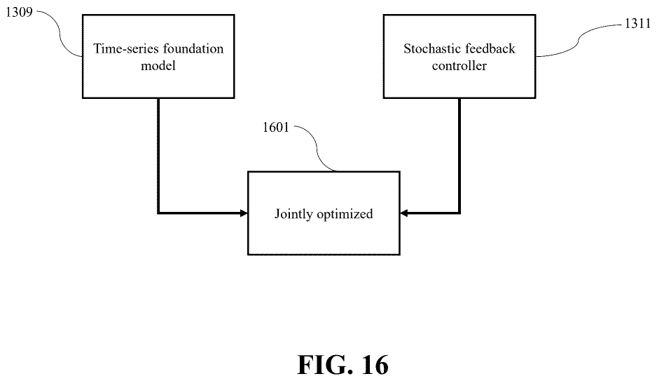

In some other embodiments, the stochastic feedback controller 1311 and the time-series foundation model 1309 are jointly optimized. FIG. 16 illustrates joint optimization the time-series foundation model 1309 and the stochastic feedback controller 1311, according to some embodiments of the present disclosure. The processor 1305 is configured to jointly optimize 1601 the time-series foundation model 1309 and the stochastic feedback controller 1311. Such a joint optimization 1601 minimizes the energy consumption of the building while maintaining indoor environmental conditions within predefined ranges. For instance, the indoor environmental conditions include a temperature and a humidity of the indoor environment. The temperature of the indoor environment is maintained within a predefined temperature range. Likewise, the humidity of the indoor environment is maintained within a predefined humidity range. The predefined ranges are defined by a user.

According to some embodiments, the time-series foundation model 1309 is fine-tuned using a dimensionality reduction technique based on low-rank approximation. The low-rank approximation is a technique used in numerical and data science applications to approximate a matrix or a high-dimensional object by a matrix of lower rank. This is typically done to reduce the complexity of data representation while maintaining essential information, making computations more efficient or reducing storage requirements. In the present disclosure, the time-series foundation model 1309 is fine-tuned using the low-rank approximation to reduce the complexity of the time-series foundation model 1309 while retaining essential predictive features.

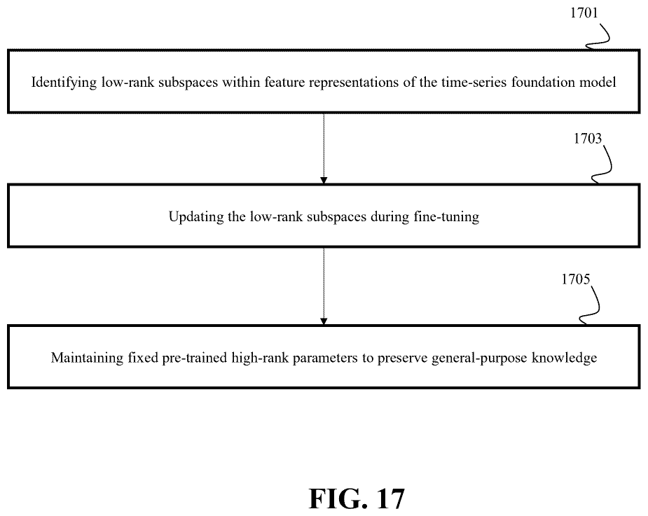

FIG. 17 illustrates a block diagram for fine-tuning the time-series foundation model 1309 using low-rank approximation, according to some embodiments of the present disclosure. The processor 1305 is configured to fine-tune the time-series foundation model 1309 using the low-rank approximation. At block 1701, the low-rank approximation includes identifying low-rank subspaces within feature representations of the time-series foundation model 1309. In the context of the time-series foundation model 1309, the low-rank subspaces refer to the underlying, reduced-dimensional structures that capture the most significant patterns or trends in the time-series data while ignoring less important, noise-like components. The low-rank subspaces represent a way to compress or approximate the time-series data, making it efficient to work with, especially when dealing with large datasets or high-dimensional problems.

At block 1703, the low-rank approximation includes updating the low-rank subspaces during the fine-tuning. At block 1705, the low-rank approximation includes maintaining fixed pre-trained high-rank parameters to preserve general-purpose knowledge of the time-series foundation model 1309. The general-purpose knowledge of the time-series foundation model 1309 corresponds to predictive capabilities acquired by the time-series foundation model 1309 after training it on the general-purpose dataset 1401. Since only the low-rank subspaces are updated during the fine-tuning, the low-rank approximation accelerates the fine-tuning of the time-series foundation model 1309 by enabling optimization over reduced parameter spaces, facilitating real-time or near-real-time model adaptation.

In some embodiments, the low-rank approximation is applied selectively to specific layers or components of the time-series foundation model 1309.

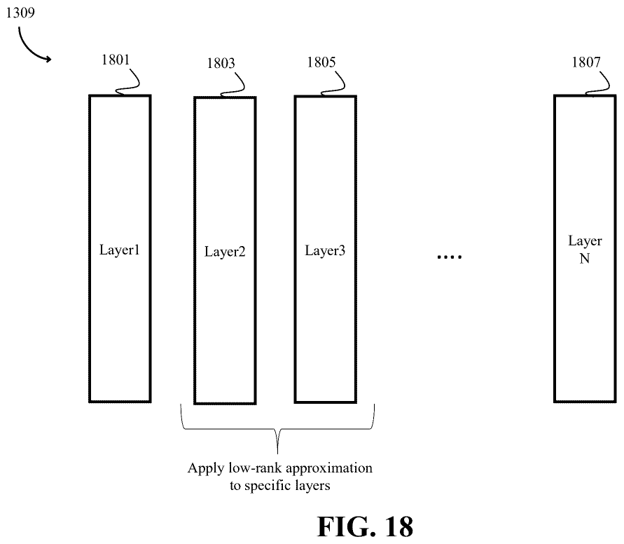

FIG. 18 illustrates applying the low-rank approximation to specific layers of the time-series foundation model 1309, according to some embodiments of the present disclosure. The time-series foundation model 1309 includes various layers such as layer1 1801, layer2 1803, layer3 1805, . . . , layerN 1807. In an embodiment, the processor 1305 is configured to apply the low-rank approximation to specific layers, e.g., layer2 1803, and layer3 1805. Applying the low-rank approximation to the specific layers of the time-series foundation model 1309 preserves pre-trained representations while adapting the time-series foundation model 1309 to the building's energy consumption patterns. Further, the low-rank approximation reduces a number of trainable parameters in the time-series foundation model 1309, enabling efficient fine-tuning on the building-specific historical data 1407 with limited computational resources.

In some embodiments, the low-rank approximation is dynamically adjusted during the fine-tuning based on available computational resources of the feedback control system 1301 or a size of the building-specific historical data 1407. Such a dynamical adjustment ensures that the low-rank approximation is applied for the fine-tuning of the time-series foundation model 1309.

Several approaches are used to train the time-series foundation model 1309. For instance, in one embodiment, the time-series foundation model 1309 is trained hierarchically by using a hierarchical training process. In another embodiment, the time-series foundation model 1309 is trained using a federated learning approach.

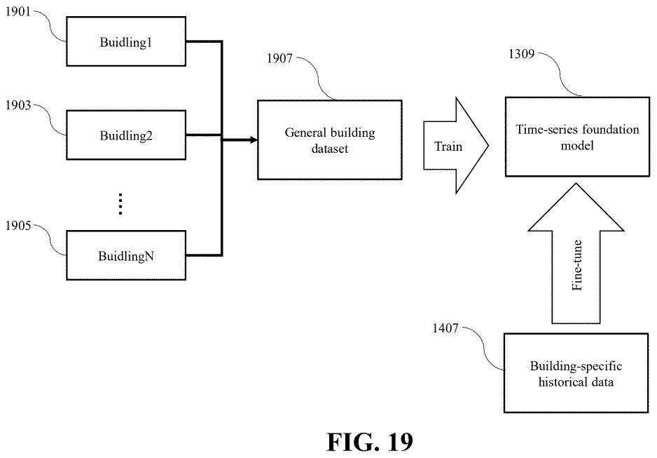

FIG. 19 illustrates the hierarchical training process, according to some embodiments of the present disclosure. At first, data is aggregated from multiple buildings, such as building1 1901, building2 1903, . . . , buildingN 1905 to form a general building dataset 1907. The data from each building includes data collected directly from energy meters or sensors in the respective building, showing the total energy usage over time (typically hourly or minute-based data). Additionally, in some embodiments, the data from each building includes occupancy patterns of the respective building that can help the model understand the correlation between the energy consumption of the HVAC system and a number of people in the building.

Further, the time-series foundation model 1309 is trained using the general building dataset 1907 to learn global patterns of energy consumption of the buildings. The time-series foundation model 1309 trained on the general building dataset 1907 is fine-tuned using the building-specific historical data 1407 to adapt to the building's energy consumption patterns.

In some cases, the building-specific historical data 1407 of the building may be sparse or incomplete. Fine tuning the time-series foundation model 1309 using such sparse or incomplete data may not result in partial or inadequate fine tuning of the time-series foundation model 1309. To mitigate this problem, the time-series foundation model 1309 is fine-tuned using data from other buildings with similar structural or operational characteristics to predict the disturbances.

In some embodiments, the time-series foundation model 1309 predicts the disturbances for unmonitored zones of the building.

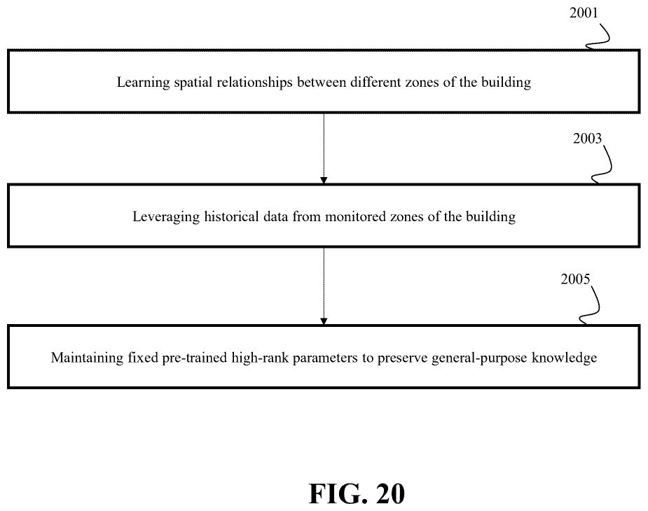

FIG. 20 shows a block diagram for predicting the disturbances for the unmonitored zones of the building, according to some embodiments of the present disclosure. At block 2001, the time-series foundation model 1309 learns spatial relationships between different zones of the building. At block 2003, the time-series foundation model 1309 leverages historical data from monitored zones of the building. The historical data from the monitored zone total energy usage over time corresponding to the monitored zone. Additionally, in some embodiments, the historical data from the monitored zone includes occupancy patterns of the monitored zone. At block 2005, the time-series foundation model 1309 extrapolates the historical data to infer the disturbances for the unmonitored zones.

Some embodiments are based on the realization that the prediction of the disturbances for the unmonitored zones can be improved by using temporal correlations between the different zones of the building, in addition to the spatial relationships between different zones of the building. To this end, the time-series foundation model uses the spatial and the temporal correlations between the different zones of the building to identify interdependencies and improve the disturbance predictions for the unmonitored zones.

In some other embodiments, the time-series foundation model 1309 is trained using the federated learning approach. The federated learning approach is a machine learning approach that enables the training of models across decentralized devices or servers holding local data, without the need to share that data with a central server. In the federated learning approach, instead of collecting all data in one place, the time-series foundation model 1309 model is trained locally on individual devices (such as edge devices, or local servers of the multiple buildings), and only the time-series foundation model 1309 updates (i.e., weights or gradients) are shared with a central server. This helps preserve privacy and reduces need for large-scale data transfers.

Examples of the federated learning approach include horizontal federated learning, vertical federated learning, and federated transfer learning. In the horizontal federated learning, the data across the multiple buildings has a same feature set but varies in sample size. In the vertical federated learning, the data across the multiple buildings includes different features but represent a same set of samples. The vertical federated learning enables collaboration without sharing actual features. The federated transfer learning involves training models when the data from the multiple buildings is heterogeneous and not aligned. The federated transfer learning allows knowledge learned on data type to be transferred to another, making the learning effective.

In yet some other embodiments, the time-series foundation model 1309 is trained using a multi-resolution learning approach. The multi-resolution approach refers to a method where the time-series foundation model 1309 is trained on data at different levels of resolution, scale, or granularity. This strategy can improve the time-series foundation model's 1309 ability to capture both fine-grained details and broader patterns by providing different “views” or “perspectives” of the data. The multi-resolution approach allows the time-series foundation model 1309 to learn from multiple resolutions or levels of abstraction, ensuring that it can effectively generalize across various scales of the data.

For example, in an embodiment, to build a model to forecast energy consumption of the building, building data is collected. The building data includes high-resolution data, i.e., hourly measurements of energy consumption, temperature, humidity, etc. The building data also includes low-resolution data, i.e., daily aggregates of energy consumption, average temperature, etc. In the multi-resolution approach, the model first learns from the low-resolution data (daily aggregates), which might capture broad trends like seasonal patterns or weekly cycles. Then, the model is fine-tuned with high-resolution data (hourly values), enabling it to capture more specific patterns such as daily peak consumption, sudden fluctuations, or localized effects.

Some embodiments are based on the recognition that the disturbances affecting the energy consumption of the building, such as the solar radiation, the occupancy patterns in the indoor environment, and the external temperature, are correlated. For instance, the solar radiation and the external temperature are related, i.e., if the solar radiation is high, then the external temperature is high and if the solar radiation is low, then the external temperature is low. However, the time-series foundation model 1309 does not capture the correlations between the disturbances to predict the disturbances. As a result, the time-series foundation model 1309 may predict the disturbances inaccurately. For example, the time-series foundation model 1309 may predict low solar radiation and high external temperature.

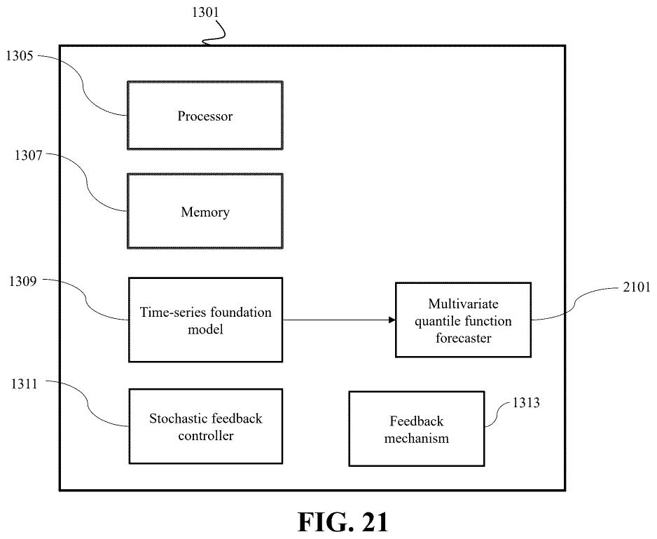

Some embodiments are based on the realization that the prediction accuracy of the time-series foundation model 1309 by modifying the time-series foundation model 1309 as a multivariate quantile function forecaster (MQF2). FIG. 21 illustrates the feedback control system 1301 including MQF2 2101, according to some embodiments of the present disclosure. In an embodiment, the MQF2 2101 is module of the feedback control system 1301 and executed by the processor 1305. The MQF2 2101 is an encoder-decoder method that allows for quantile-based representation of multivariate predictions. The MQF2 2101 is trained to learn the correlations among the disturbances as hidden vector outputs of the time-series foundation model 1309 set up as an encoder. During inference, the MQF2 2101 predicts the disturbances by considering the correlations among the disturbances, based on decoding of the hidden vector outputs from the time-series foundation model 1309. In an embodiment, the hidden vector outputs from the time-series foundation model 1309 are indicative of the disturbances predicted by the time-series foundation model 1309.

To this end, since the disturbances are predicted by considering the correlations among the disturbances, the MQF2 2101 predicts either (i) high solar radiation and high eternal temperature or (ii) low solar radiation and low external temperature, as opposed to low solar radiation and high external temperature. In other words, the prediction accuracy of the disturbances is improved. Further, based on such accurately predicted disturbances, the stochastic feedback controller 1311 determines the control inputs to the GIB system 1303 that optimize the performance of the GIB system 1303 while achieving the desired indoor environmental conditions. Since the stochastic feedback controller 1311 determines the control inputs based on such accurately predicted disturbances, the performance of the GIB system 1303 is optimized effectively while accurately achieving the desired indoor environmental conditions.

In some embodiments, the time-series foundation model 1309 is a Temporal Fusion Transformer (TFT) model and the TFT model is modified to form the MQF2. For example, a partially input convex neural network (PICNN) is added to the TFT model. Further, input/output structure of the TFT model is modified. In an embodiment, modifying the output structure of the TFT model includes recasting an output vector of the TFT model at each time t+τ as hidden output vector h_{t+τ}.

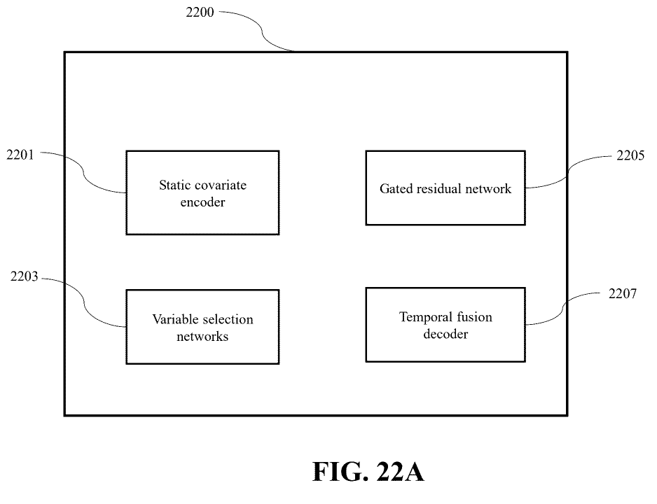

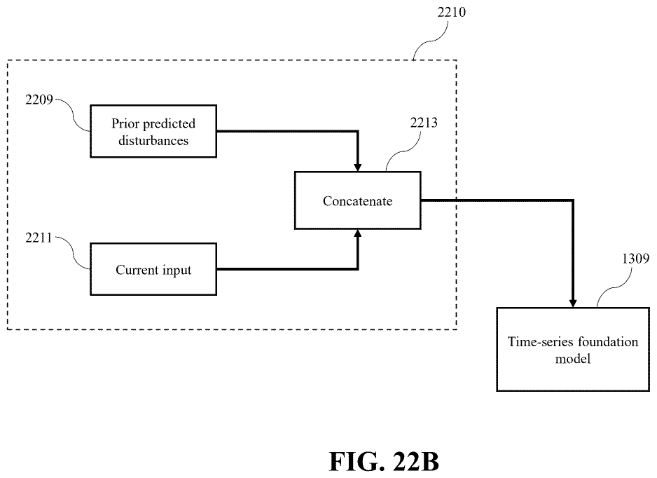

FIG. 22A shows a block diagram of a TFT 2200 that forms the MQF2 2101, according to some embodiments of the present disclosure. The TFT 2200 includes a static covariate encoder 2201, variable selection networks (VSNs) 2203, a gated residual network 2205, and a temporal fusion decoder 2207. Each of these is described below.

The static covariate encoder 2201: The static covariate encoder 2201 is configured to integrate static features into the architecture, through encoding of context vectors to condition temporal dynamics. Handling multivariate case, i.e., N target scalar variables represented by target vector y∈R rather than a single one, requires some changes to an original TFT model. The VSNs, which aggregate all target and covariate inputs, independently for each timestamp, are readily adaptable to accept a target vector by adding needed input channels to each VSN. More specifically, this simply means a target scalar yₜ₋ⱼ is replaced by a target vector yₜ₋ⱼ in an encoder VSN input χₜ₋ⱼ for past time t−j=t−k . . . t

The VSNs 2203 are configured to select relevant input variables at each time step. The gated residual network 2205 is configured to skip over any unused components of the architecture, providing adaptive depth and network complexity to accommodate a wide range of datasets and scenarios.

The temporal fusion decoder 2207/TFT output: The original TFT model predicts a set of quantiles \hat{q}_{t+τ} representing a distribution of a target scalar variable y_{t+τ} at time t+τ. Simply changing to outputting one set of quantiles per target variable (i.e., N sets) is often undesirable as it means modeling N target variables as independent from each other. However, correlated target variables are expected, limiting meaning and usefulness of independent quantile predictions. Another option is to revert to parametric distributions, e.g., multivariate Gaussians. In order to maintain flexibility of non-parametric distributions, the PICNN is leveraged. The PICNN is trained to map a hidden vector h (aka hidden output vector) and a “query” vector α into target predictions, with the network being convex with respect to α. Prediction is obtained as a gradient ∇_{α}G_{θ} (α, h). Being interpretable as multivariate quantile values, α is then a vector of Ni.i.d. random variables with distribution U(0, 1). Further, an output vector of the original TFT model at each time t+τ is recasted as the hidden output vector h_{t+τ}. Combined with a quantile vector α_{t+τ}, it is then mapped to target predictions ŷ_{t+τ} through the MQF2 PICNN.

Prediction feedback: The original (causal) TFT models distribution quantiles of future target value ŷ_{t+τ} as conditioned on (i) past time-dependent known and measured variables χ_{t-k:t} (which includes measured past target values Y_{t-k:t}); (ii) static covariates s; and, (iii) known future (but past with respect to the prediction) time-dependent covariates x_{t+1:t+τ}. Hence, correlations between the predictions at different times cannot be recovered.

It is an objective of some embodiments to consider correlations between the disturbances predicted at different times, i.e., to model the correlation in time.

Some embodiments are based on the realization that the correlations between the disturbances predicted at different times can be considered by modifying an input to the time-series foundation model 1309.

FIG. 22B illustrates a modified input 2210 to the time-series foundation model 1309, according to some embodiments of the present disclosure. The modified input 2210 includes prior disturbance predictions 2209 and a current input 2211. The prior disturbance predictions 2209 correspond to the disturbances predicted at previous time instances. The prior disturbance predictions 2209 may be stored in the memory 1307 or retrieved from an external memory. The current input 2211 includes the real-time data 1315. The prior disturbance predictions 2209 and the current input 2211 are concatenated 2213 to form the modified input 2210 to the time-series foundation model 1309.

The modified input 2210 is input to the time-series foundation model 1309. The time-series foundation model 1309 predicts new disturbances affecting the energy consumption of the building based on the modified input 2210. Predicting the new disturbances based on the prior disturbance predictions 2209 and the current input 2211, makes the predictions of the disturbances auto-regressive in time.

In some embodiments, the time-series foundation model 1309 is the TFT model and the TFT model can also account for the correlations between the predictions at different times. Here, these correlations are accounted by also conditioning prediction of ŷ_{t+τ} on past predictions ŷ_{t+1:t+τ-1}. As the original TFT model is causal, this can be accomplished by only modifying input/output structure of the original TFT model as to make the prediction auto-regressive. Meaning, the prediction ŷ_{t+τ-1} from prior time t+τ−1 to original time-dependent input of decoder VSN at time t+τ, i.e., x_{t+τ} are concatenated, effectively resulting in a VSN with additional time-dependent input channels. Note that, for consistency, the decoder VSN for the first prediction time t+1 is fed known past yₜ even as it is also included in the encoder VSN input χₜ.

Training: At training, ground-truth future target values are collected. As such, the TFT model can be trained with so-called “teacher forcing” by feeding ground-truth yₜ₊₁ through y_{t+τmax} to the decoder VSNs corresponding to time t+1 through t+τₘₐₓ. Training loss or time t+τ is an approximated multivariate energy score. Meaning, randomly draw 3 sets of M quantile vectors α_{t+τ} (indexed, respectively, with m, m′ and, m″), compute respective predictions ŷ_{t+τ} as ∇_{α}G_{θ}(α_{t+τ}, h_{t+τ}) and then compute

$$- \frac{1}{2} {\sum }_{m , {m}^{′}} {‖ {\hat{y}}_{t + τ}^{( m )} - {\hat{y}}_{t + τ}^{( {m}^{′} )} ‖}_{2}^{β} + {\sum }_{{m}^{″}} {‖ {y}_{t + τ} - {\hat{y}}_{t + τ}^{( {m}^{″} )} ‖}_{2}^{β}$$

Inference: As each predicted time depends on earlier predictions, once the hidden output vector h_{t+τ-1} for time t+τ−1 is iteratively computed, a quantile vector α_{t+τ-1} is sampled from Ni.i.d. U(0, 1). Then a new target prediction sample ŷ_{t+τ-1} is generated using ∇_{α}G_{θ} before feeding it to the decoder VSN of the next iteration for time t+τ.

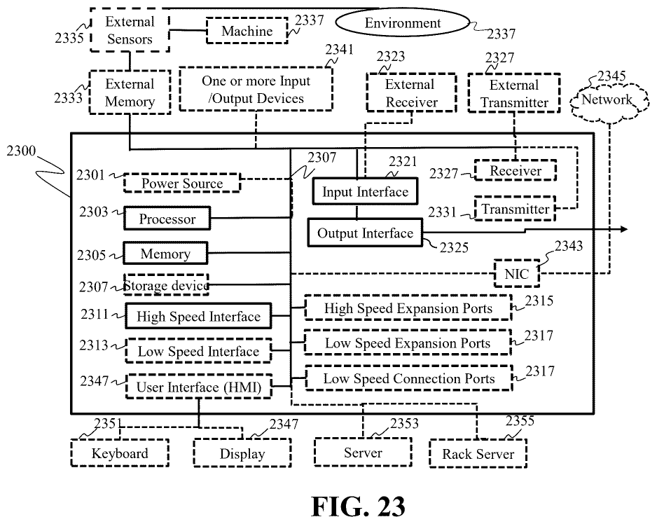

FIG. 23 is a schematic illustrating by non-limiting example a computing apparatus for implementing the methods and the systems of the present disclosure. The computing device 2300 can include a power source 2301, a processor 2303, a memory 2305, a storage device 2307, all connected to a bus 2309. Further, a high-speed interface 2311, a low-speed interface 2313, high-speed expansion ports 2315 and low speed connection ports 2317, can be connected to the bus 2309. In addition, a low-speed expansion port 2319 is in connection with the bus 2309. Further, an input interface 2321 can be connected via the bus 2309 to an external receiver 2323 and an output interface 2325. A receiver 2327 can be connected to an external transmitter 2329 and a transmitter 2331 via the bus 2309. Also connected to the bus 2309 can be an external memory 2333, external sensors 2335, machine(s) 2337, and an environment 2339. Further, one or more external input/output devices 2341 can be connected to the bus 2309. A network interface controller (NIC) 2343 can be adapted to connect through the bus 2309 to a network 2345, wherein data or other data, among other things, can be rendered on a third-party display device, third party imaging device, and/or third-party printing device outside of the computer device 2300.

The memory 2305 can store instructions that are executable by the computer device 2300, historical data, and any data that can be utilized by the methods and systems of the present disclosure. The memory 2305 can include random access memory (RAM), read only memory (ROM), flash memory, or any other suitable memory systems. The memory 2305 can be a volatile memory unit or units, and/or a non-volatile memory unit or units. The memory 2305 may also be another form of computer-readable medium, such as a magnetic or optical disk.

The storage device 2307 can be adapted to store supplementary data and/or software modules used by the computer device 2300. For example, the storage device 2307 can store historical data and other related data as mentioned above regarding the present disclosure. Additionally, or alternatively, the storage device 2307 can store historical data like data as mentioned above regarding the present disclosure. The storage device 2307 can include a hard drive, an optical drive, a thumb-drive, an array of drives, or any combinations thereof. Further, the storage device 2307 can contain a computer-readable medium, such as a floppy disk device, a hard disk device, an optical disk device, or a tape device, a flash memory or other similar solid-state memory device, or an array of devices, including devices in a storage area network or other configurations. Instructions can be stored in an information carrier. The instructions, when executed by one or more processing devices (for example, the processor 2303), perform one or more methods, such as those described above.

The computing device 2300 can be linked through the bus 2309, optionally, to a display interface or user Interface (HMI) 2347 adapted to connect the computing device 2300 to a display device 2349 and a keyboard 2351, wherein the display device 2349 can include a computer monitor, camera, television, projector, or mobile device, among others. In some implementations, the computer device 2300 may include a printer interface to connect to a printing device, wherein the printing device can include a liquid inkjet printer, solid ink printer, large-scale commercial printer, thermal printer, UV printer, or dye-sublimation printer, among others.

The high-speed interface 2311 manages bandwidth-intensive operations for the computing device 2300, while the low-speed interface 2313 manages lower bandwidth-intensive operations. Such allocation of functions is an example only. In some implementations, the high-speed interface 2311 can be coupled to the memory 2305, the user interface (HMI) 2347, and to the keyboard 2351 and the display 2349 (e.g., through a graphics processor or accelerator), and to the high-speed expansion ports 2315, which may accept various expansion cards via the bus 2309. In an implementation, the low-speed interface 2313 is coupled to the storage device 2307 and the low-speed expansion ports 2317, via the bus 2309. The low-speed expansion ports 2317, which may include various communication ports (e.g., USB, Bluetooth, Ethernet, wireless Ethernet) may be coupled to the one or more input/output devices 2341. The computing device 2300 may be connected to a server 2353 and a rack server 2355. The computing device 2300 may be implemented in several different forms. For example, the computing device 2300 may be implemented as part of the rack server 2355.

The description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments.

Further, embodiments of the present disclosure and the functional operations described in this specification can be implemented in digital electronic circuitry, in tangibly-embodied computer software or firmware, in computer hardware, including the structures disclosed in this specification and their structural equivalents, or in combinations of one or more of them. Further some embodiments of the present disclosure can be implemented as one or more computer programs, i.e., one or more modules of computer program instructions encoded on a tangible non transitory program carrier for execution by, or to control the performance of, data processing apparatus. Further still, program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

According to embodiments of the present disclosure the term “data processing apparatus” can encompass all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code.

A computer program can be deployed to be executed on one computer or on multiple computers that are located at one site or distributed across multiple sites and interconnected by a communication network. Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

We claim:

1. A feedback control system for optimizing performance of a grid-interactive building (GIB) system that is configured to condition an indoor environment of a building, comprising:
a time-series foundation model configured to predict disturbances affecting energy consumption of the building;
a stochastic feedback controller configured to: determine control inputs for the GIB system by evaluating multiple control actions for the GIB system based on the predicted disturbances affecting energy consumption of the building, wherein the control inputs maximize a likelihood of achieving desired indoor environmental conditions while minimizing the energy consumption; and
a feedback mechanism configured to:
collect real-time data that includes indoor environmental conditions, an actual energy consumption, and external factors;
fine-tune the time-series foundation model using the collected real-time data; and
update the stochastic feedback controller based on a deviation between predicted data and the collected real-time data.

2. The feedback control system of claim 1, wherein the stochastic feedback controller uses Bayesian inference to evaluate the multiple control actions for the GIB system.

3. The feedback control system of claim 1, wherein the stochastic feedback controller uses a stochastic optimization technique to evaluate the multiple control actions for the GIB system.

4. The feedback control system of claim 1, wherein the time-series foundation model is pre-trained on a general-purpose dataset.

5. The feedback control system of claim 4, wherein the time-series foundation model pre-trained on the general-purpose dataset is fine-tuned using building-specific historical data to adapt to building's energy consumption patterns.

6. The feedback control system of claim 1, wherein the feedback mechanism is further configured to update the time-series foundation model based on the real-time data using a reinforcement learning framework.

7. The feedback control system of claim 1, wherein the stochastic feedback controller and the time-series foundation model are jointly optimized to minimize the energy consumption while maintaining indoor environmental conditions within predefined ranges.

8. The feedback control system of claim 1, wherein the time-series foundation model is fine-tuned using low-rank approximation to reduce the complexity of the time-series foundation model while retaining essential predictive features.

9. The feedback control system of claim 8, wherein fine-tuning using the low-rank approximation includes:
identifying low-rank subspaces within the feature representations of the time-series foundation model;
updating the low-rank subspaces during fine-tuning; and
maintaining fixed pre-trained high-rank parameters to preserve general-purpose knowledge of the time-series foundation model.

10. The feedback control system of claim 8, wherein the low-rank approximation is applied to specific layers of the time-series foundation model, preserving pre-trained representations while adapting the time-series foundation model to building's energy consumption patterns.

11. The feedback control system of claim 8, wherein the low-rank approximation is dynamically adjusted during the fine-tuning based on available computational resources of the feedback control system or a size of building-specific historical data.

12. The feedback control system of claim 1, wherein the time-series foundation model is trained hierarchically by:
learning global patterns from data aggregated from multiple buildings; and
fine-tuning on building-specific historical data to adapt to building's energy consumption patterns.

13. The feedback control system of claim 1, wherein the time-series foundation model is fine-tuned using data from other buildings with similar structural or operational characteristics to predict the disturbances.

14. The feedback control system of claim 1, wherein the time-series foundation model predicts the disturbances for unmonitored zones of the building by:
learning spatial relationships between different zones of the building;
leveraging historical data from monitored zones of the building; and
extrapolating the historical data to infer disturbances for the unmonitored zones.

15. The feedback control system of claim 13, wherein the time-series foundation model uses spatial and temporal correlations between the different zones of the building to identify interdependencies and improve disturbance predictions for the unmonitored zones.

16. The feedback control system of claim 1, wherein the time-series foundation model is trained using one of a federated learning approach and a multi-resolution learning approach.

17. The feedback control system of claim 17, wherein, in the multi-resolution learning approach, the time-series foundation model is trained on data at different levels of resolution and scale.

18. The feedback control system of claim 1, further comprising a multivariate quantile function forecaster configured to predict the disturbances affecting the energy consumption of the building by considering correlations among the disturbances, based on hidden vector outputs of the time-series foundation model.

19. The feedback control system of claim 18, wherein the multivariate quantile function forecaster is a modified Temporal Fusion Transformer (TFT) model.

20. The feedback control system of claim 1, wherein the time-series foundation model is further configured to predict new disturbances affecting the energy consumption of the building auto-regressively in time, based on prior predicted disturbances and the real-time data.

21. A method for optimizing performance of a grid-interactive building (GIB) system that is configured to condition an indoor environment of a building, comprising:
predicting, by a time-series foundation model, disturbances affecting energy consumption of the building;
determining, by a stochastic feedback controller, control inputs for the GIB system by evaluating multiple control actions for the GIB system based on the predicted disturbances affecting energy consumption of the building, wherein the control inputs maximize a likelihood of achieving desired indoor environmental conditions while minimizing the energy consumption;
collecting, by a feedback mechanism, real-time data that includes indoor environmental conditions, an actual energy consumption, and external factors;
fine-tuning, by the feedback mechanism, the time-series foundation model using the collected real-time data; and
updating, by the feedback mechanism, the stochastic feedback controller based on a deviation between predicted data and the collected real-time data.

22. A non-transitory computer readable storage medium embodied thereon a program executable by a processor for performing a method for optimizing performance of a grid-interactive building (GIB) system that is configured to condition an indoor environment of a building, the method comprising:
predicting, by a time-series foundation model, disturbances affecting energy consumption of the building;
determining, by a stochastic feedback controller, control inputs for the GIB system by evaluating multiple control actions for the GIB system based on the predicted disturbances affecting energy consumption of the building, wherein the control inputs maximize a likelihood of achieving desired indoor environmental conditions while minimizing the energy consumption;
collecting, by a feedback mechanism, real-time data that includes indoor environmental conditions, an actual energy consumption, and external factors;
fine-tuning, by the feedback mechanism, the time-series foundation model using the collected real-time data; and
updating, by the feedback mechanism, the stochastic feedback controller based on a deviation between predicted data and the collected real-time data.
